(19) United States
(12) Patent Application Publication
(10) Pub. No.: US 2025/0310996 A1
(43) Pub. Date: Oct. 2, 2025

(54) MICROWAVE SENSING DEVICE AND METHOD FOR AVOIDING TRANSMISSION COLLISION IN UNLICENSED BAND

(71) Applicant: Realtek Semiconductor Corp., HsinChu (TW)

(72) Inventors: MINGZHI GUO, Suzhou City (CN); YING YANG, Suzhou City (CN)

(73) Assignee: Realtek Semiconductor Corp., HsinChu (TW)

(21) Appl. No.: 19/078,313

(22) Filed: Mar. 13, 2025

(30) Foreign Application Priority Data
Apr. 2, 2024 (CN) 202410397370.7

(51) Int. Cl. H04W 74/0816; H04W 24/08

(52) U.S. Cl. CPC H04W 74/0816; H04W 24/08

(57) ABSTRACT

A microwave sensing device includes: a generation circuit, for generating a microwave sensing packet according to a wireless communication protocol; a detecting circuit, for detecting whether a channel is idle; a transmitting circuit, coupled to the generation circuit and the detecting circuit, for transmitting the microwave sensing packet in response to the channel being idle; a receiving circuit, coupled to the detecting circuit, for receiving a received microwave sensing packet corresponding to the microwave sensing packet; and a processing circuit, coupled to the receiving circuit, for determining whether the received microwave sensing packet comprises an interference.

### BACKGROUND OF THE INVENTION

### 1. Field of the Invention

The present invention relates to a microwave sensing device and a method used in a wireless communication system, and more particularly, to a microwave sensing device and a method for avoiding a transmission collision in an unlicensed band.

### 2. Description of the Prior Art

A microwave sensing device usually operates in an unlicensed band. In the unlicensed band, communication devices of other wireless communication system also exist. When the microwave sensing device and the communication device use the same band and are physically located close to each other, a transmission collision occurs, making it impossible for the microwave sensing device and the communication device to recognize signals. In the prior art, a dynamic frequency selective mechanism defines that the microwave sensing device has a higher priority than that of the communication device to avoid the transmission collision. However, a frequency of signals transmitted by the microwave sensing device is very low and a duration of the transmitted signals is very short, resulting in a low utilization rate of the unlicensed band. Thus, how to effectively use the unlicensed band and avoid the transmission collision is an important problem to be solved.

### SUMMARY OF THE INVENTION

The present invention provides a microwave sensing device and a method to solve the abovementioned problem.

A microwave sensing device comprises: a generation circuit, for generating a microwave sensing packet according to a wireless communication protocol; a detecting circuit, for detecting whether a channel is idle; a transmitting circuit, coupled to the generation circuit and the detecting circuit, for transmitting the microwave sensing packet in response to the channel being idle; a receiving circuit, coupled to the detecting circuit, for receiving a received microwave sensing packet corresponding to the microwave sensing packet; and a processing circuit, coupled to the receiving circuit, for determining whether the received microwave sensing packet comprises an interference.

A method for avoiding a transmission collision in an unlicensed band comprises: generating a microwave sensing packet according to a wireless communication protocol; detecting whether a channel is idle; transmitting the microwave sensing packet in response to the channel being idle; receiving a received microwave sensing packet corresponding to the microwave sensing packet; and determining whether the received microwave sensing packet comprises an interference.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a microwave sensing device according to an example of the present invention.

FIG. 2 is a schematic diagram of a microwave sensing packet according to an example of the present invention.

FIG. 3 is a schematic diagram of a microwave sensing packet according to an example of the present invention.

FIG. 4 is a flowchart of a process according to an example of the present invention.

### DETAILED DESCRIPTION

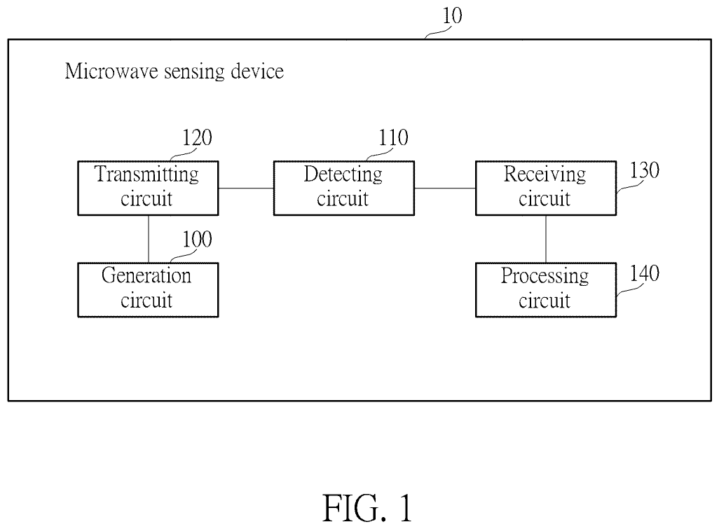

FIG. 1 is a schematic diagram of a microwave sensing device 10 according to an example of the present invention. The microwave sensing device 10 may operate in an unlicensed band (such as, but not limited to, 2.4G or 5.8G), and is an electronic device that senses motion, presence or range via a microwave radar. The microwave sensing device 10 may be used in various applications, such as, but not limited to, weather measurement, military applications, security systems, traffic management, contactless switches, lighting controls, parking sensors, etc. In FIG. 1, the microwave sensing device 10 comprises a generation circuit 100, a detecting circuit 110, a transmitting circuit 120, a receiving circuit 130 and a processing circuit 140. In detail, the generation circuit 100 is configured to generate a microwave sensing packet according to a wireless communication protocol. The detecting circuit 110 is configured to detect whether a channel is idle. The transmitting circuit 120 is coupled to the generation circuit 100 and the detecting circuit 110, and is configured to transmit the microwave sensing packet in response to the channel being idle. The receiving circuit 130 is coupled to the detecting circuit 110, and is configured to receive a received microwave sensing packet corresponding to the microwave sensing packet. In one example, the microwave sensing packet is reflected by an object to generate the received microwave sensing packet, after the transmitting circuit 120 transmits the microwave sensing packet. The processing circuit 140 is coupled to the receiving circuit 130, and is configured to determine whether the received microwave sensing packet comprises an interference.

In one example, the wireless communication protocol comprises, but is not limited to, a communication protocol for a local area network (LAN) (e.g., WiFi), a communication protocol for a personal area network (PAN) (e.g., Bluetooth (BT)) or a ZigBee protocol. In one example, the detecting circuit 110 continues to detect whether the channel is idle in response to the channel not being idle. In one example, the transmitting circuit 120 does not transmit the microwave sensing packet in response to the channel not being idle.

In one example, the microwave sensing packet comprises a wrapper and a single tone signal. In one example, a content of the wrapper is fixed. That is, the wrapper may be generated in advance (e. g., via hardware or software). In one example, the single tone signal comprises, but is not limited to, a continuous wave (CW) or a frequency modulated continuous wave (FMCW).

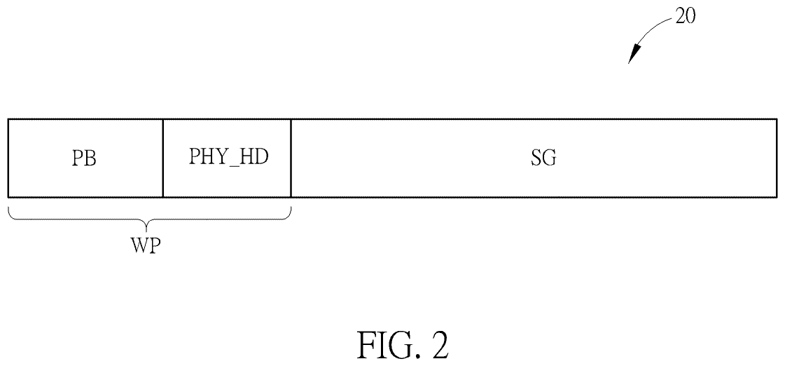

In one example, the wrapper comprises a preamble and a physical (PHY) layer header. Refer to FIG. 2 for details. In FIG. 2, the microwave sensing packet 20 comprises a wrapper WP and a single tone signal SG. The wrapper WP comprises a preamble PB and a PHY layer header PHY HD. In one example, the PHY layer header indicates a length of the single tone signal.

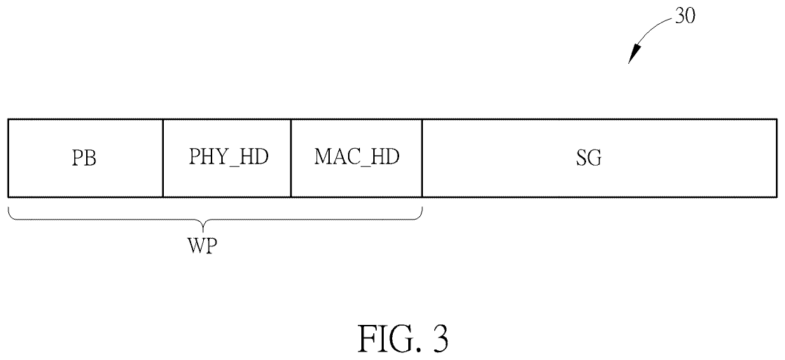

In one example, the wrapper comprises a preamble, a PHY layer header and a medium access control (MAC) layer header. Refer to FIG. 3 for details. In FIG. 3, the microwave sensing packet 30 comprises a wrapper WP and a single tone signal SG. The wrapper WP comprises a preamble PB, a PHY layer header PHY HD and a MAC layer header MAC HD. In one example, the PHY layer header indicates a sum of lengths of the MAC layer header and the single tone signal (i.e., a length of a PHY layer payload), and the MAC layer header indicates a length of the single tone signal.

In one example, the transmitting circuit 120 transmits at least one packet to a communication device which uses the wireless communication protocol. In one example, the at least one packet is used for declaring a channel occupancy. That is, the communication device knows that the microwave sensing device 10 occupies the channel according to the at least one packet. In one example, the at least one packet comprises, but is not limited to, a Request to Send packet and/or a Confirm to Send packet.

In one example, an operation for the detecting circuit 110 to detect whether the channel is idle comprises: generating a local sequence according to the preamble; matching the local sequence and a received signal received in the channel, to generate a matching result; determining that the channel is not idle in response to the matching result being greater than (or not smaller than) a first threshold; and determining that the channel is idle in response to the matching result being not greater than (or smaller than) the first threshold. In one example, the received signal is received by the receiving circuit 130.

In one example, the operation for the detecting circuit 110 to detect whether the channel is idle comprises: calculating (or checking) a power of a received signal received in the channel; determining that the channel is not idle in response to the power being greater than (or not smaller than) a second threshold; and determining that the channel is idle in response to the power being not greater than (or smaller than) the second threshold. In one example, the received signal is received by the receiving circuit 130.

In one example, the processing circuit 140 drops the received microwave sensing packet in response to the received microwave sensing packet comprising the interference. In one example, the transmitting circuit 120 retransmits the microwave sensing packet while the channel is idle, after the processing circuit 140 drops the received microwave sensing packet. In one example, the operation for the processing circuit 140 to determine whether the received microwave sensing packet comprises the interference comprises: calculating (or checking) a signal power out of band; determining that the received microwave sensing packet comprises the interference in response to the signal power being greater than (or not smaller than) a third threshold; and determining that the received microwave sensing packet does not comprise the interference in response to the signal power being not greater than (or smaller than) the third threshold. For example, assuming that a sampling frequency Fs of an analog-to-digital converter (ADC) in the microwave sensing device 10 (not shown in FIG. 1) is greater than an effective bandwidth Fc of the microwave sensing packet, the processing circuit 140 may calculate (or check) the signal power of the bands

$$[ - \frac{{F}_{S}}{2} \sim - \frac{{F}_{C}}{2} ] and [ \frac{{F}_{C}}{2} \sim \frac{{F}_{S}}{2} ] .$$

The processing circuit 140 determines that the received microwave sensing packet comprises the interference and drops the received microwave sensing packet, if the signal power is greater than (or not smaller than) the third threshold. The processing circuit 140 determines that the received microwave sensing packet does not comprise the interference and keeps processing the received microwave sensing packet, if the signal power is not greater than (or smaller than) the third threshold.

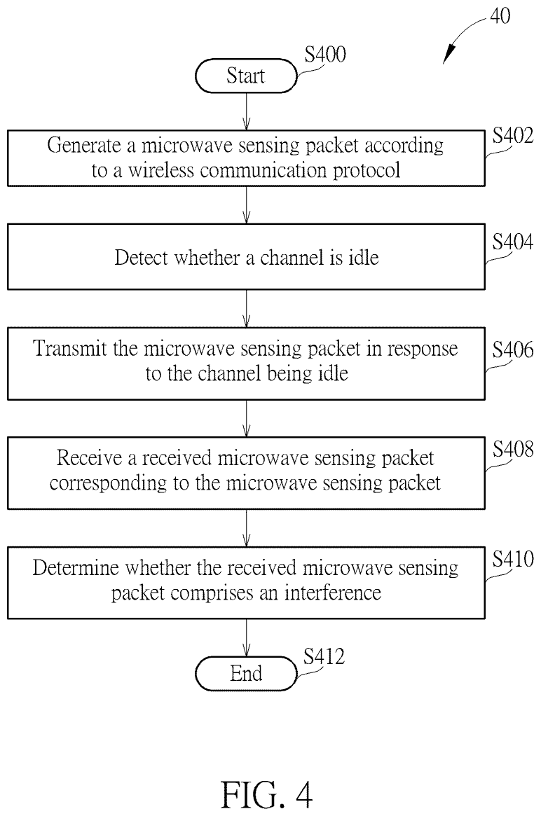

Operations of the microwave sensing device 10 in the above examples can be summarized into a process 40 shown in FIG. 4, which includes the following steps:
Step S400: Start.
Step S402: Generate a microwave sensing packet according to a wireless communication protocol.
Step S404: Detect whether a channel is idle.
Step S406: Transmit the microwave sensing packet in response to the channel being idle.
Step S408: Receive a received microwave sensing packet corresponding to the microwave sensing packet.
Step S410: Determine whether the received microwave sensing packet comprises an interference.
Step S412: End.

A detailed description and variations of the process 40 can be known by referring to the above description, and are not narrated herein.

It should be noted that there are various possible realizations of the microwave sensing device 10 (including the generation circuit 100, the detecting circuit 110, the transmitting circuit 120, the receiving circuit 130 and the processing circuit 140). For example, the circuits mentioned above may be integrated into one or more circuits. In addition, the microwave sensing device 10 and the circuits in the microwave sensing device 10 may be realized by hardware (e.g. circuits), software, firmware (known as a combination of a hardware device, computer instructions and data that reside as read-only software on the hardware device), an electronic system or a combination of the devices mentioned above, but are not limited herein.

The term of “preamble” described above may be replaced by “training field”. The operation of “determine” described above may be replaced by the operation of “compute”, “calculate”, “obtain”, “generate”, “output, “use”, “choose/select”, “decide” or “is configured to”. The operation of “detect” described above may be replaced by the operation of “monitor”, “receive”, “sense” or “obtain”. The phrase of “according to” described above may be replaced by “in response to”. The term of “corresponding to” described above may be replaced by “of” or “associated with”. The term of “via” described above may be replaced by “on”, “in” or “at”. The term of “when” or “if” described above may be replaced by “in response to”.

To sum up, the present invention provides a microwave sensing device and a method for voiding a transmission collision in an unlicensed band. The microwave sensing device generates and transmits a microwave sensing packet according to a wireless communication protocol. A communication device which uses the wireless communication protocol knows packet information of the microwave sensing packet (e.g., a length of the microwave sensing packet) according to a wrapper of the microwave sensing packet, after the communication device receives the microwave sensing packet. The communication device does not perform data transmission during packet transmission according to the packet information. Thus, the transmission collision between the microwave sensing device and the communication device does not occur, when the microwave sensing device transmits the microwave sensing packet.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A microwave sensing device, comprising:
a generation circuit, for generating a microwave sensing packet according to a wireless communication protocol;
a detecting circuit, for detecting whether a channel is idle;
a transmitting circuit, coupled to the generation circuit and the detecting circuit, for transmitting the microwave sensing packet in response to the channel being idle;
a receiving circuit, coupled to the detecting circuit, for receiving a received microwave sensing packet corresponding to the microwave sensing packet; and
a processing circuit, coupled to the receiving circuit, for determining whether the received microwave sensing packet comprises an interference.

2. The microwave sensing device of claim 1, wherein the detecting circuit continues to detect whether the channel is idle in response to the channel not being idle.

3. The microwave sensing device of claim 1, wherein the transmitting circuit does not transmit the microwave sensing packet in response to the channel not being idle.

4. The microwave sensing device of claim 1, wherein the microwave sensing packet comprises a wrapper and a single tone signal.

5. The microwave sensing device of claim 4, wherein a content of the wrapper is fixed.

6. The microwave sensing device of claim 4, wherein the wrapper comprises a preamble and a physical (PHY) layer header.

7. The microwave sensing device of claim 6, wherein the PHY layer header indicates a length of the single tone signal.

8. The microwave sensing device of claim 4, wherein the wrapper comprises a preamble, a PHY layer header and a medium access control (MAC) layer header.

9. The microwave sensing device of claim 8, wherein the PHY layer header indicates a sum of lengths of the MAC layer header and the single tone signal, and the MAC layer header indicates a length of the single tone signal.

10. The microwave sensing device of claim 1, wherein the processing circuit drops the received microwave sensing packet in response to the received microwave sensing packet comprising the interference.

11. A method for avoiding a transmission collision in an unlicensed band, comprising:
generating a microwave sensing packet according to a wireless communication protocol;
detecting whether a channel is idle;
transmitting the microwave sensing packet in response to the channel being idle;
receiving a received microwave sensing packet corresponding to the microwave sensing packet; and
determining whether the received microwave sensing packet comprises an interference.

12. The method of claim 11, further comprising:
continuing to detect whether the channel is idle in response to the channel not being idle.

13. The method of claim 11, further comprising:
not transmitting the microwave sensing packet in response to the channel not being idle.

14. The method of claim 11, wherein the microwave sensing packet comprises a wrapper and a single tone signal.

15. The method of claim 14, wherein a content of the wrapper is fixed.

16. The method of claim 14, wherein the wrapper comprises a preamble and a physical (PHY) layer header.

17. The method of claim 16, wherein the PHY layer header indicates a length of the single tone signal.

18. The method of claim 14, wherein the wrapper comprises a preamble, a PHY layer header and a medium access control (MAC) layer header.

19. The method of claim 18, wherein the PHY layer header indicates a sum of lengths of the MAC layer header and the single tone signal, and the MAC layer header indicates a length of the single tone signal.

20. The method of claim 11, further comprising:
dropping the received microwave sensing packet in response to the received microwave sensing packet comprising the interference.
